(19) United States
(12) Patent Application Publication
(10) Pub. No.: US 2017/0236223 A1
(43) Pub. Date: Aug. 17, 2017

(54) PERSONALIZED TRAVEL PLANNER THAT IDENTIFIES SURPRISING EVENTS AND POINTS OF INTEREST

(71) Applicant: International Business Machines Corporation, Armonk, NY (US)

(72) Inventors: Mishal Dholakia, Danbury, CT (US); Shang Q. Guo, Cortland Manor, NY (US); Jonathan Lenchner, North Salem, NY (US); Florian Pinel, New York, NY (US); Yedendra B. Shrinivasan, Yorktown Heights, NY (US)

(21) Appl. No.: 15/041,469

(22) Filed: Feb. 11, 2016

(51) Int. Cl. G06Q 50/14; G06Q 10/10

(52) U.S. Cl. CPC G06Q 50/14; G06Q 10/1093

(57) ABSTRACT

Methods, systems, and computer program products for automatically identifying surprising travel events and/or points of interest for a user are provided herein. A computer-implemented method includes identifying a plurality of potential items for the user; determining a personality type profile for the user using a personality assessment tool; determining a travel personality type and/or a travel personality type profile for the user based on a mapping of a plurality of user personality types to a plurality of predefined travel personality types; determining a personality type profile for the potential items using the personality assessment tool; identifying at least one potential item for the user by matching the personality type profile of the user to the personality type profile for the plurality of potential items; filtering the identified at least one potential item based on predefined surprise criteria; and selecting at least one filtered item for the user that satisfies the predefined surprise criteria.

### FIELD

The present application generally relates to techniques for travel planning, and, more particularly, to methods and apparatus for generating a personalized travel itinerary for a user.

### BACKGROUND

As people work increasingly long hours, their leisure time becomes even more valuable. As a result, people are spending more money on leisure travel than they have in the past. There are many travel web sites and other services to help users plan their travel. A number of techniques have been proposed or suggested to identify personalized travel itinerary items that match the tastes of a user. Typically, users are asked a series of questions to ascertain their tastes, which can take a significant amount of time to answer. In addition, any given set of questions will be limited and may miss important aspects of the user and his or her interests.

When people travel, they often seek out what they consider to be surprising, unique or unusual experiences. Often, however, after relating these experiences to an acquaintance, the person may learn that a particular experience, previously thought to be unique, was also experienced by the acquaintance. For example, a user may post pictures of the unique experience on social media, only to see a comment on the post stating “Wasn't that great—I did that too!”

A need therefore exists for a personalized travel planner that identifies surprising and/or unique events and points of interest for a user. A further need exists for a personalized travel planner that identifies surprising events and points of interest for a user based on a determined personality type of the user.

### SUMMARY

In one embodiment of the present invention, techniques are provided for automatically identifying surprising travel events and/or points of interest for a user. An exemplary computer-implemented method can include identifying a plurality of potential items for the user; determining a personality type profile for the user using a personality assessment tool, wherein the tool is executed by at least one processing device; determining, using at least one processing device, one or more of a travel personality type and a travel personality type profile for the user based on a mapping of a plurality of user personality types to a plurality of predefined travel personality types; determining a personality type profile for the plurality of potential items using the personality assessment tool, wherein the tool is executed by at least one processing device; identifying, using at least one processing device, at least one of the plurality of potential items for the user by matching the personality type profile of the user to the personality type profile for the plurality of potential items; filtering, using at least one processing device, the identified at least one potential item based on one or more predefined surprise criteria; and selecting at least one filtered item for the user that satisfies the one or more predefined surprise criteria, wherein at least one of said predefined surprise criteria are based on one or more of the travel personality type and the travel personality profile of the user.

Another embodiment of the invention or elements thereof can be implemented in the form of an article of manufacture tangibly embodying computer readable instructions which, when implemented, cause a computer to carry out a plurality of method steps, as described herein. Furthermore, another embodiment of the invention or elements thereof can be implemented in the form of an apparatus including a memory and at least one processor that is coupled to the memory and configured to perform the noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture, according to an exemplary embodiment of the invention;

FIG. 2A is a diagram illustrating the user personality type classifier of FIG. 1 in further detail;

FIG. 2B is a bar graph illustrating an exemplary mapping from personality types to traveler personality types, in accordance with an embodiment of the invention;

FIG. 3 is a diagram illustrating the point of interest (POI)/event personality type classifier of FIG. 1 in further detail;

FIG. 4 is a diagram illustrating an exemplary travel type-to-POI/event classifier, according to an exemplary embodiment of the invention;

FIG. 5 is a diagram illustrating an exemplary POI/event surprise classifier, according to an exemplary embodiment of the invention; and

FIG. 6 is a system diagram of an exemplary computer system on which at least one embodiment of the invention can be implemented.

### DETAILED DESCRIPTION

As described herein, an embodiment of the present invention includes a personalized travel planner that identifies surprising and/or unique events and points of interest for a user. At least one embodiment of the invention includes processing content of a user, such as writings, speeches and social media posts, using a personality assessment tool or a personality type classifier, such as IBM Personality Insights™ personality type classifier, to obtain a detailed personality type profile of the user across a range of psychographic categories. The personality type profile of the user is then mapped to an established set of travel personality types, such as those developed by Stanley Plog (See, Stanley Plog, “The Power of Psychographics and the Concept of Venturesomeness,” Journal of Travel Research, Vol. 40, No. 3, 244-251 (2002)) to obtain an estimate of the user's travel personality type(s). As discussed further below, the personality type profile can be based, for example, on a Myers-Briggs personality type profile or another personality type profile, such as the skills and behavior predictive index administered by the company PI Worldwide (https://en.wikipedia.org/wiki/Predictive_Index).

In addition, a personality type profile is determined for a plurality of potential travel items for the user, such as points of interests and events (e.g., sporting events and concerts). For example, the personalized travel planning system can obtain or learn a score of how strongly a given point of interest or event is associated with each of the different personality types. For example, the exemplary personalized travel planner can obtain the personality type profile of a specific itinerary item by supplying available descriptions and reviews of the itinerary item found on the Internet to the personality type assessment tool, and from it, obtain a personality type assessment.

At least one of the potential travel items is identified for the user by matching the personality type of the user to the personality type of the potential travel items. The potential travel items that match the personality type of the user are then filtered based on various surprise criteria. In one or more exemplary embodiments, surprise is assessed, for example, by: (1) determining what classes of itinerary items (both points of interest and events) the user is least likely to think of, given his or her travel personality type; (2) mining the descriptions and reviews of itinerary items to see if they use descriptive terms indicative of being surprising, for example, words like “quirky,” “little known,” “out of the way,” etc.; and/or (3) looking for items that have few reviews compared to other items. The personalized travel planning system then aims to optimize for items that match the user personality-wise, but are in a class (the “surprise class”) such that the user wouldn't ordinarily think of, or consider them.

In this manner, aspects of the invention provide a system and method that delivers personalized travel itinerary items and/or detailed itineraries by obtaining a location of interest from a traveler. In at least one embodiment, the invention includes the steps of: automatically finding potential itinerary items by searching the web for points of interest and events; assessing a traveler's personality type by applying a collection of his/her writings and other content, such as social media posts, to a personality assessment tool; matching the traveler's personality type profile to known travel personality types to obtain the traveler's travel personality type (profile); searching for descriptions and reviews of potential itinerary items found in the location of interest and applying these potential itinerary items to the same personality type profiler to obtain a personality type profile for each potential itinerary item. The personality type profile of the traveler is then matched to that of the potential itinerary items to evaluate compatibility. Surprise is assessed, for example, by looking at the classes of itinerary items that the traveler's travel personality type is least likely to consider. Itinerary items are selected that are substantially optimized for compatibility while also substantially optimized for surprise.

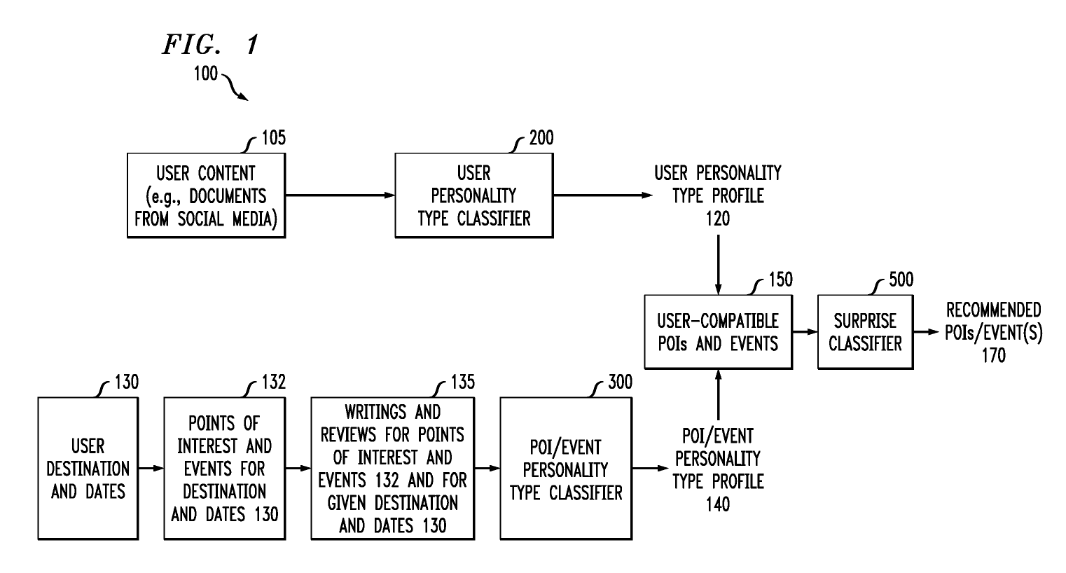

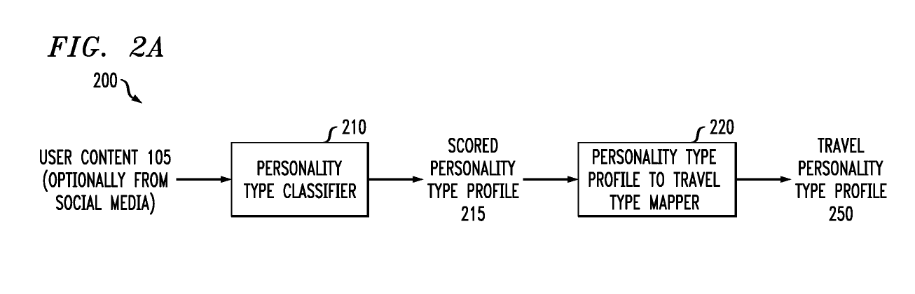

FIG. 1 is a diagram illustrating a system architecture 100, according to an exemplary embodiment of the invention. As shown in FIG. 1, a user personality type classifier 200, discussed further below in conjunction with FIG. 2, processes user content 105 (such as documents and other items from social media) to generate a user personality type profile 120 for the user.

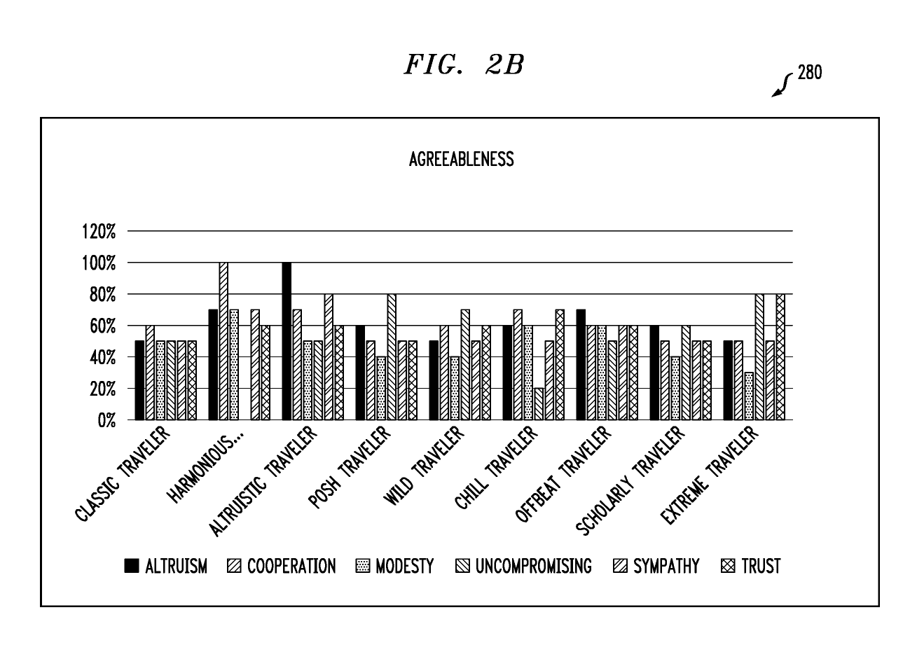

In addition, the user specifies a destination of interest and dates of travel 130. A POI/event personality type classifier 300, discussed further below in conjunction with FIG. 3, obtains the user-specified destination and dates of travel 130, from which the POI/event personality type classifier 300 (or another processing entity) generates potential points of interest and events 132. For these potential points of interest and events 132 at the given location and during the data of travel 130, the POI/event personality type classifier 300 (or another processing entity) then finds associated writings and/or reviews 135. From these writings and reviews 135, the system generates a personality type profile 140 for the POIs and events at the user-specified destination and travel time 130.

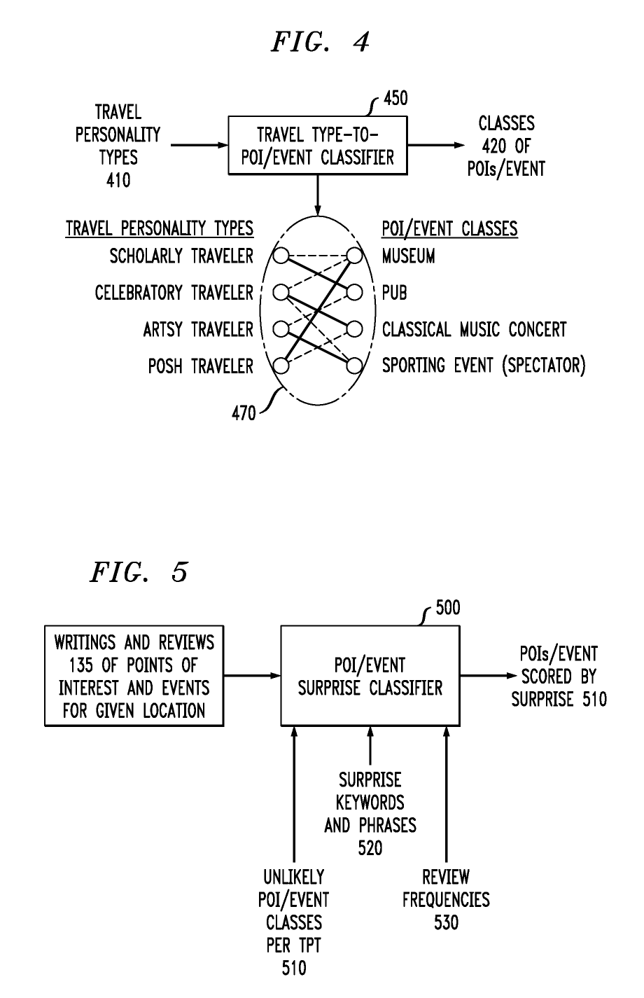

User compatible POIs and Events 150 are then obtained by determining which POIs and Events have personality type profiles that most closely match the personality type profile of the user. The compatible POIs and Events 150 are processed by a surprise classifier 500, discussed further below in conjunction with FIG. 5, that filters the potential travel items 150 based on predefined surprise criteria. In one or more exemplary embodiments, the exemplary surprise classifier 500 assesses surprise, for example, by looking for classes of travel items that a given person would not typically consider, given their travel personality type, and/or looking for little known places/events. Little known places/events can be identified by (i) mining the writings and/or reviews 135 to see if they use indicative words such as “quirky,” “little known,” and “out of the way;” or if travel items have relatively few reviews. The surprise classifier 500 identifies a set of recommended POIs/event(s) 170 that match the user personality wise, but are in a class (the “surprise class”) such that the user wouldn't ordinarily think of or consider them.

FIG. 2A is a diagram illustrating the user personality type classifier 200 of FIG. 1 in further detail. Generally, the exemplary user travel personality type classifier 200 obtains a user's travel personality type by analyzing user provided textual material, here referred to as “user content” 105, such as social media posts by or about the user. The user content 105 is applied to a personality assessment tool or personality type classifier 210, such as IBM Personality Insights™ personality type classifier, to obtain a detailed personality type profile 215 of the user.

For example, the exemplary personality type classifier 210 employs the following sample personality types: altruism, cooperation, modesty, uncompromisingness, sympathy, trust, adventurousness, imagination, intellect, (tendency to be) authority-challenging, cautiousness, achievement striving, assertiveness, and immoderation, among others.

The following personality traits are often referred to as the “Big Five personality traits:” (1) Agreeableness is a person's tendency to be compassionate and cooperative toward others. (2) Conscientiousness is a person's tendency to act in an organized or thoughtful way. (3) Extraversion is a person's tendency to seek stimulation in the company of others. (4) Emotional Range, also referred to as Neuroticism or Natural Reactions, is the extent to which a person's emotions are sensitive to the person's environment. Finally, (5) Openness is the extent to which a person is open to experiencing a variety of activities.

The IBM Watson™ Personality Insights™ service, for example, provides an Application Programming Interface (API) that enables applications to derive insights regarding the personalities of authors of social media or other textual matter. The service uses linguistic analysis to infer personality and social characteristics, subsumed under the Big Five personality traits, from text. These insights help businesses to understand their clients' preferences and improve customer satisfaction by anticipating customer needs and recommending future actions. Businesses can use these insights to improve client acquisition, retention, and engagement, and to strengthen relations with their clients.

The personality type profile 215 of the user is then mapped to a given set of travel personality types 250 by a personality type-to-travel type mapper 220, to obtain an estimate of the user's travel personality type(s) 250. Generally, each predefined personality type is mapped by the personality type-to-travel type mapper 220 to one or more predefined travel personality types. In one exemplary embodiment, the following sample travel personality types are employed: classic traveler, harmonious traveler, altruistic traveler, posh traveler, wild traveler, chill traveler, offbeat traveler, scholarly traveler, extreme traveler, celebratory traveler, artsy traveler, curious traveler, traditionalist traveler, compassionate traveler, daydreaming traveler and competitive traveler. For example, a score can be assigned to each personality type/travel personality type pair indicating their respective correlation.

FIG. 2B is a bar graph 200 illustrating an exemplary mapping from a number of exemplary personality types to a number of exemplary traveler personality types, in accordance with an embodiment of the invention. For example, as shown in FIG. 2B, the exemplary bar graph 200 illustrates the correlation between the travel personality types of classic traveler, harmonious traveler, altruistic traveler, posh traveler, wild traveler, chill traveler, offbeat traveler, scholarly traveler and extreme traveler and the exemplary user personality types of altruism, cooperation, modesty, uncompromising, sympathy and trust. Each of these personality types are part of the larger personality type grouping called “Agreeableness”—one of the Big Five, as previously discussed, though this grouping is not itself directly mapped or correlated with the various travel personality types.

FIG. 3 is a diagram illustrating the point of interest (POI)/event personality type classifier 300 of FIG. 1 in further detail. Generally, the exemplary POI/event personality type classifier 300 obtains a personality type of a given POI and/or an event, and also classifies the given POI/event.

As shown in FIG. 3, the user-specified destination and dates of travel 130 are used to identify a plurality of points of interest 310 and events 320 related to the destination and dates of travel 130 (for example, using TripAdvisor™, Foursquare™, Google Places™, Google Maps™, and eventful.com). The personality type classifier 210 processes descriptions and/or reviews 325 of the points of interest 310 and events 320 to generate the personality type profile 140 for the points of interest 310 and events 320. Generally, the compatibility of a specific itinerary item (i.e., a point of interest or event) is assessed by processing available descriptions and reviews 325 of the itinerary item 310, 320 (e.g., found on the web) to the personality type classifier 210 (e.g. IBM Personality Insights™ personality type assessment tool), and obtaining a personality type assessment 140 for the itinerary item itself.

Similarly, a POI/event classifier 340 processes the descriptions and/or reviews 325 of the points of interest 310 and events 320 to generate classifications 350 of the POIs 310 and events 320. For example, the exemplary POI/event classifier 340 can employ a hand-crafted master list of classifications, including such things as museum, theater, athletic event (spectator), athletic event (participant), etc. There are a number of alternative, published, classifications of points of interest and/or events, including that of the UK Ordinance Survey: http://s3.amazonaws.com/zanran_storage/www.ordnancesurvey.co.uk/ContentPages/253 2798912.pdf. The description of each point of interest 310 or event 320 is then mined to obtain the best matching classification.

In one or more embodiments, the above-mentioned exemplary classification scheme is employed for points of interest or events, including, but not limited to the following classes: museum, cultural site, historical site, natural wonder, sporting event (spectator), sporting event (participant), concert (popular), concert (classical) and concert (jazz).

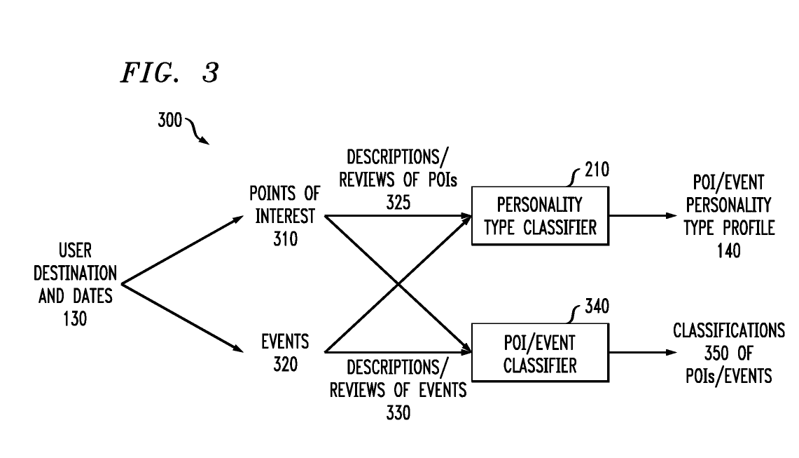

FIG. 4 illustrates an exemplary mapping of travel personality types of users to point of interest and event classifications, according to an exemplary embodiment of the invention. As shown in FIG. 4, a travel type-to-POI/event classifier 450 processes travel personality types 410 and classes 420 of points of interest and events. For each travel type and POI/Event class pair, the travel type-to-POI/event classifier 450 generates a confidence score indicating the correlation between the given travel type and POI/Event class (travel type, POI or Event class, confidence).

For example, the travel type-to-POI/event classifier 450 can generate the following exemplary triples: (Classic traveler, Museum, 0.5); and (Celebratory traveler, Popular music concert, 0.8).

FIG. 5 is a diagram illustrating an exemplary POI/event surprise classifier 500, according to an exemplary embodiment of the invention. As shown in FIG. 5, the exemplary surprise classifier 500 processes the writings and/or reviews 135 regarding the points of interest and events for the user-specified destination 130; and one or more of a set 510 of unlikely POI/event classes, based on the user's travel personality type (TPT); a set of predefined surprised keywords 520 and review frequencies 530 for POIs/events.

The surprise classifier 500 generates a set of compatible POIs/events 510, scored by surprise. In this manner, the surprise classifier 500 ensures that there is a compatible chemistry with the recommended items (e.g., the “personality type profile” of the point of interest/event matches the personality profile of the user) and that the point of interest/event classification does not match with what the user would normally do. For example, if a user is a Wild (i.e., wilderness) Traveler, the user would not normally consider going to a theater performance. However, the system could, for example, recommend the play “Willi”, a one person play about the life of mountaineer Willi Unsoeld that might be playing in town.

The set of predefined surprise keywords and phrases 520 can also be used to mine the description and reviews 135 of points of interest and events to find little known or obscure places/events. For example, in Paris everyone goes to the Louvre but there are many great, much lesser known, art museums, such as the Rodin museum and Le Centre Pompidou. This provides an additional dimension to measure surprise.

The techniques described herein can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques described herein can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

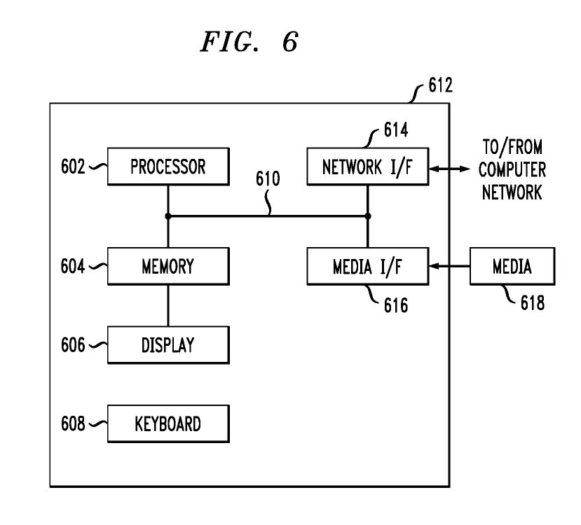

Additionally, an embodiment of the present invention can make use of software running on a computer or workstation. With reference to FIG. 6, such an implementation might employ, for example, a processor 602, a memory 604, and an input/output interface formed, for example, by a display 606 and a keyboard 608. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 602, memory 604, and input/output interface such as display 606 and keyboard 608 can be interconnected, for example, via bus 610 as part of a data processing unit 612. Suitable interconnections, for example via bus 610, can also be provided to a network interface 614, such as a network card, which can be provided to interface with a computer network, and to a media interface 616, such as a diskette or CD-ROM drive, which can be provided to interface with media 618.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 602 coupled directly or indirectly to memory elements 604 through a system bus 610. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 608, displays 606, pointing devices, and the like) can be coupled to the system either directly (such as via bus 610) or through intervening I/O controllers (omitted for clarity).

Network adapters such as network interface 614 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 612 as shown in FIG. 6) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out embodiments of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments of the present invention.

Embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 602. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, implementing a personalized travel planner that identifies surprising and/or unique events and points of interest for a user.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
identifying a plurality of potential items for said user;
determining a personality type profile for said user using a personality assessment tool, wherein said tool is executed by at least one processing device;
determining, using at least one processing device, one or more of a travel personality type and a travel personality type profile for said user based on a mapping of a plurality of user personality types to a plurality of predefined travel personality types;
determining a personality type profile for said plurality of potential items using said personality assessment tool, wherein said tool is executed by at least one processing device;
identifying, using at least one processing device, at least one of said plurality of potential items for said user by matching the personality type profile of the user to the personality type profile for said plurality of potential items;
filtering, using at least one processing device, said identified at least one potential item based on one or more predefined surprise criteria; and
selecting at least one filtered item for said user that satisfies said one or more predefined surprise criteria, wherein at least one of said predefined surprise criteria are based on one or more of the travel personality type and the travel personality profile of the user.

2. The computer-implemented method of claim 1, wherein the plurality of potential items are selected based on one or more of a location of interest of the user and dates of travel of the user.

3. The computer-implemented method of claim 1, wherein the plurality of potential items comprise one or more of points of interest and events.

4. The computer-implemented method of claim 1, wherein the one or more of the travel personality type and the travel personality type profile for said user is determined by analyzing a collection of content of the user using the personality assessment tool.

5. The computer-implemented method of claim 1, wherein the one or more predefined surprise criteria comprise one or more of membership in one or more of a list of classes of items that the user is unlikely to select based on the one or more of the travel personality type and the travel personality type profile of the user, a list of predefined keywords indicating surprise, and a threshold number of reviews of a given item.

6. The computer-implemented method of claim 1, wherein the step of determining a personality type profile for said plurality of potential items further comprises the step of determining a travel personality type for said plurality of potential items.

7. The computer-implemented method of claim 1, wherein the mapping of the plurality of personality types to the plurality of predefined travel personality types provides a score for each pair of personality type and predefined travel personality type.

8. A computer program product comprising a computer readable storage medium having program instructions embodied therewith, the program instructions executable by a device to cause the device to:
identify a plurality of potential items for said user;
determine a personality type profile for said user using a personality assessment tool, wherein said tool is executed by at least one processing device;
determine, using at least one processing device, one or more of a travel personality type and a travel personality type profile for said user based on a mapping of a plurality of user personality types to a plurality of predefined travel personality types;
determine a personality type profile for said plurality of potential items using said personality assessment tool, wherein said tool is executed by at least one processing device;
identify, using at least one processing device, at least one of said plurality of potential items for said user by matching the personality type profile of the user to the personality type profile for said plurality of potential items;
filter, using at least one processing device, said identified at least one potential item based on one or more predefined surprise criteria; and
select at least one filtered item for said user that satisfies said one or more predefined surprise criteria, wherein at least one of said predefined surprise criteria are based on one or more of the travel personality type and the travel personality profile of the user.

9. The computer program product of claim 8, wherein the plurality of potential items are selected based on one or more of a location of interest of the user and dates of travel of the user.

10. The computer program product of claim 8, wherein the plurality of potential items comprise one or more of points of interest and events.

11. The computer program product of claim 8, wherein the one or more of the travel personality type and the travel personality type profile for said user is determined by analyzing a collection of content of the user using the personality assessment tool.

12. The computer program product of claim 8, wherein the one or more predefined surprise criteria comprise one or more of membership in one or more of a list of classes of items that the user is unlikely to select based on the one or more of the travel personality type and the travel personality type profile of the user, a list of predefined keywords indicating surprise, and a threshold number of reviews of a given item.

13. The computer program product of claim 8, wherein personality type profile for said plurality of potential items is determined by determining a travel personality type for said plurality of potential items.

14. The computer program product of claim 8, wherein the mapping of the plurality of personality types to the plurality of predefined travel personality types provides a score for each pair of personality type and predefined travel personality type.

15. A system comprising:
a memory; and
at least one processor coupled to the memory and configured for:
identifying a plurality of potential items for said user;
determining a personality type profile for said user using a personality assessment tool, wherein said tool is executed by at least one processing device;
determining, using at least one processing device, one or more of a travel personality type and a travel personality type profile for said user based on a mapping of a plurality of user personality types to a plurality of predefined travel personality types;
determining a personality type profile for said plurality of potential items using said personality assessment tool, wherein said tool is executed by at least one processing device;
identifying, using at least one processing device, at least one of said plurality of potential items for said user by matching the personality type profile of the user to the personality type profile for said plurality of potential items;
filtering, using at least one processing device, said identified at least one potential item based on one or more predefined surprise criteria; and
selecting at least one filtered item for said user that satisfies said one or more predefined surprise criteria, wherein at least one of said predefined surprise criteria are based on one or more of the travel personality type and the travel personality profile of the user.

16. The system of claim 15, wherein the plurality of potential items are selected based on one or more of a location of interest of the user and dates of travel of the user.

17. The system of claim 15, wherein the plurality of potential items comprise one or more of points of interest and events.

18. The system of claim 15, wherein the one or more of the travel personality type and the travel personality type profile for said user is determined by analyzing a collection of content of the user using the personality assessment tool.

19. The system of claim 15, wherein the one or more predefined surprise criteria comprise one or more of membership in one or more of a list of classes of items that the user is unlikely to select based on the one or more of the travel personality type and the travel personality type profile of the user, a list of predefined keywords indicating surprise, and a threshold number of reviews of a given item.

20. The system of claim 15, wherein the mapping of the plurality of personality types to the plurality of predefined travel personality types provides a score for each pair of personality type and predefined travel personality type.
